(19) United States
(12) Patent Application Publication
(10) Pub. No.: US 2014/0188623 A1
(43) Pub. Date: Jul. 3, 2014

(54) ADVERTISEMENT GENERATION BASED UPON SOCIAL MEDIA POSTING

(71) Applicant: INTERNATIONAL BUSINESS MACHINES, Armonk, NY (US)

(72) Inventors: Kristin E. McNeil, Charlotte, NC (US); Soomi Mun, Stallings, NC (US)

(73) Assignee: INTERNATIONAL BUSINESS MACHINES CORPORATION, Armonk, NY (US)

(21) Appl. No.: 13/733,278

(22) Filed: Jan. 3, 2013

(51) Int. Cl. G06Q 30/02; G06Q 50/00

(52) U.S. Cl. CPC G06Q 30/0269; G06Q 50/01
USPC 705/14.66

(57) ABSTRACT

A method, computer program product, and system for: (i) SBTA processing of an SMW posting, made by a first user, to determine whether a potential commercial transaction, somehow related to the SMW posting, is likely; and (ii) on condition that a likely potential commercial transaction has been determined by the SBTA processing, placing an advertisement to help facilitate the potential commercial transaction. Software-based natural language processing type text analytics (SBTA) is the derivation of high-quality information from the subject natural language text using software based dictionaries and rules which are applied to the subject natural language text.

### FIELD OF THE INVENTION

The present invention relates generally to the fields of software-based text analytics and social media websites, and more particularly to software-based text analytic processing of social media website text related to potential incipient commercial activity.

### BACKGROUND OF THE INVENTION

Software-based natural language processing type text analytics (SBTA) is known. Under conventional STBA techniques, first, data corresponding to a piece of text (herein sometimes called the “subject text”) is provided. This piece of text will generally be written in a “natural language.” As used herein, the term “natural language” means as follows: any language which arises in an unpremeditated fashion as the result of the innate facility for language possessed by the human intellect. The English language is one example of a natural language. The subject text, to be subject to SBTA, is written, or otherwise generated, by an entity that is herein sometimes called the “author.” The author is generally, but not necessarily, a human.

SBTA is the derivation of high-quality information from the subject natural language text using software based dictionaries and rules which are applied to the subject natural language text. SBTA may include other features and/or characteristics, such as: (i) high-quality information derived from natural language subject text through the devising of patterns and trends through means such as statistical pattern learning; (ii) text categorization; (iii) text clustering; (iv) concept/entity extraction; (v) production of granular taxonomies; (vi) sentiment analysis; (vii) document summarization; (viii) entity relation modeling (that is, learning relations between named entities); (ix) information retrieval; (x) lexical analysis to study word frequency distributions; (xi) pattern recognition; (xii) tagging/annotation; (xiii) information extraction; (xiv) data mining techniques (including link and association analysis); (xv) visualization; (xvi) predictive analytics; (xvii) use of parsing rules; and/or (xviii) use of character rules.

UIMA (Unstructured Information Management Architecture) is an industry standard for content analytics, which can be used to help make SBTA software for performing software-based natural language type text analytics. UIMA is a component software architecture for the development, discovery, composition and/or deployment of multi-modal analytics for the analysis of unstructured information and its integration with search technologies. Further information on content analytics is available at the following website (which reflects knowledge which is typically known by those of skill in the relevant art): http://www-01.ibm.com/software/ecm/content-analytics/.

Social media websites (SMWs), and the software that creates, manages and controls SMWs, is also known. An SMW is an interactive web platform by which individuals and communities share, co-create, discuss, modify user-generated content, and/or mediate human communication. Two currently-popular examples of SMWs are: Twitter and Facebook. (Notes: (i) “Facebook” and/or “Twitter” may be subject to trademark rights in various jurisdiction(s) throughout the world; and (ii) references to these marks herein are to be taken to refer only to authorized goods and services of the respective owner(s) of these respective potential trademarks).

Some SMWs sell advertisements to third parties. These advertisements are usually directed at end users of the SMW.

In many SMWs, a first user will have one or more groups of other selected users to whom the first user is considered to be socially related. These groups of socially-related users are typically called “friends,” “connections,” “circles,” or the like. The establishment of this social relationship (for example, friend, connection) may require both parties to agree to the designation of the social relationship, but this is not always necessarily required. The establishment of the social relationship may require (or at least encourage) socially related parties to have a relationship outside of the context of the SMW, but this is also not always necessarily required. Herein, social relationships like friends, connections, circles and the like will be generically referred to as a “set of SMW-related-users” and/or “SMW-related-users.”

### SUMMARY

Embodiments of the present invention disclose a method, computer program product, and system for: (i) SBTA processing of an SMW posting (see definitions section), made by a first user (see definitions section), to determine whether a potential commercial transaction (see definitions section), somehow related to the SMW posting, is likely; and (ii) on condition that a likely potential commercial transaction has been determined by the SBTA processing, placing an advertisement (see definition herein) to help facilitate the potential commercial transaction. In some preferred embodiments, the advertisement will be directed to, at least, a set of SMW-related-users of the first user. In some preferred embodiments, the advertisement will be directed exclusively to a set of SMW-related-users of the first user.

In some preferred embodiments, the first user will be offered the opportunity to have performed (or not have performed) the sales-related activity after step (i) identified in the preceding paragraph, but before step (ii) identified in the preceding paragraph. In some embodiments, the advertisement will take the form of a flag that is displayed with the SMW posting to the set of SMW-related-users of the first user.

According to an aspect of the present invention, a method includes a receiving step, an analyzing step and a replacing step. The receiving step includes receiving a posting. The analyzing step includes analyzing the posting to determine whether a potential commercial transaction related to natural language content of the posting is likely. The placing step includes, on condition that a likely potential commercial transaction has been determined by the analyzing step, placing an advertisement to help facilitate the potential commercial transaction. At least the analyzing step is performed by computer software running on computer hardware.

The following paragraphs provide definitions for certain term(s) used in this document:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

User: includes, but is not necessarily limited to, the following: (i) a single individual human; (ii) an artificial intelligence entity with sufficient intelligence to act as a user; and/or (iii) a group of related users.

Commercial transaction: includes, but is not necessarily limited to, outright sales and purchase, rentals, leases, licenses, time share, barter arrangements, charitable donations and so on.

advertisement: includes, but is not necessarily limited to, advertisements distributed over a computer (such as banner advertisements on a webpage, email-based advertisements, advertisements present in a smart phone operating system splash screen, etc.), direct postal mail advertisements and so on; however, it should be noted that some types of advertising (such as advertising in a broadcast television signal) are not susceptible to being directed at a particular user; advertisements may relate to any kind of commercial transaction (as the phrase “commercial transaction” is defined herein).

SMW posting: refers to a single SMW posting, or a set of multiple, related SMW postings.

### BRIEF DESCRIPTION OF THE SEVERAL VIEWS OF THE DRAWINGS

FIG. 1 is a schematic view of a first embodiment of a computer system according to the present invention;

FIG. 2A is a schematic view of a server computer sub-system portion of the first embodiment computer system;

FIG. 2B is a schematic view of a client computer sub-system portion of the first embodiment computer system;

FIG. 3 is a schematic view of a commerce module portion of the first embodiment computer system;

FIG. 4 is a flowchart showing a process according to the present invention;

FIG. 5A is a first screenshot generated by the first embodiment computer system;

FIG. 5B is a second screenshot generated by the first embodiment computer system;

FIG. 5C is a third screenshot generated by the first embodiment computer system; and

FIG. 5D is a fourth screenshot generated by the first embodiment computer system.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

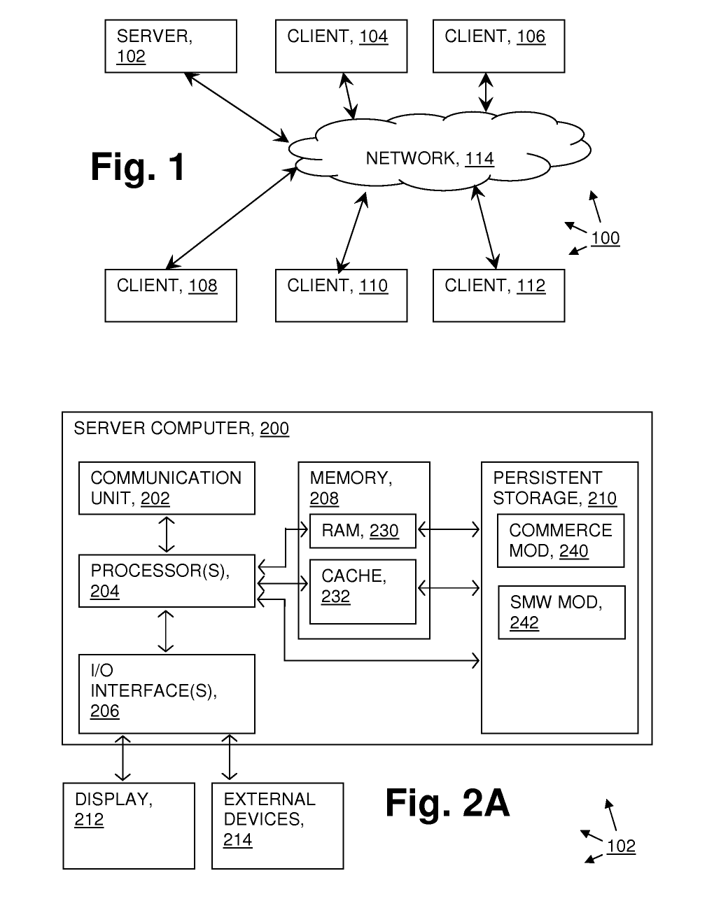

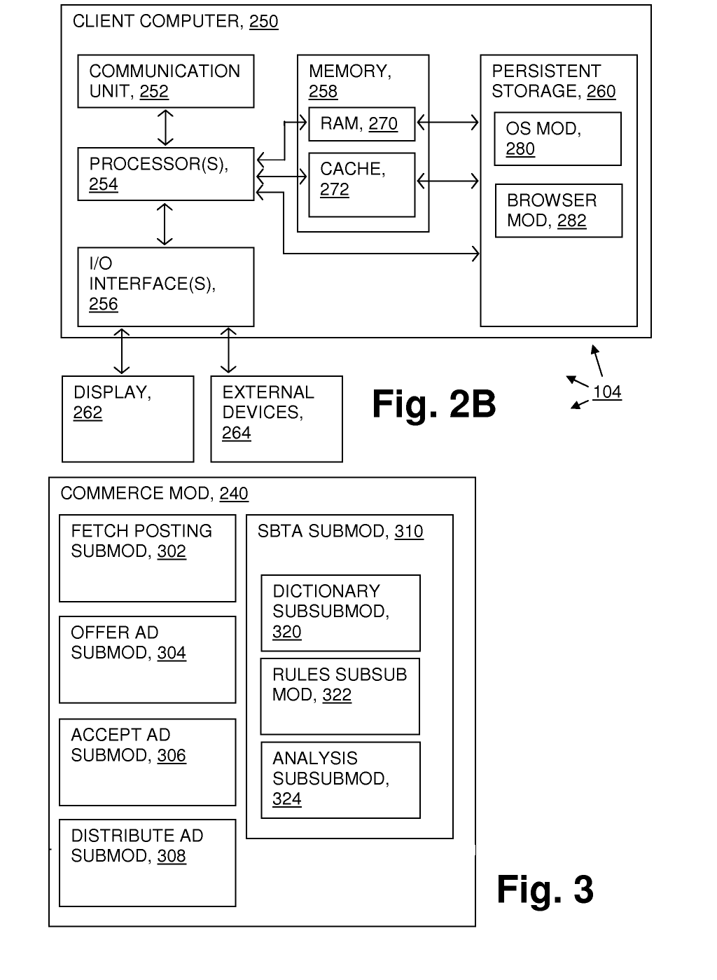

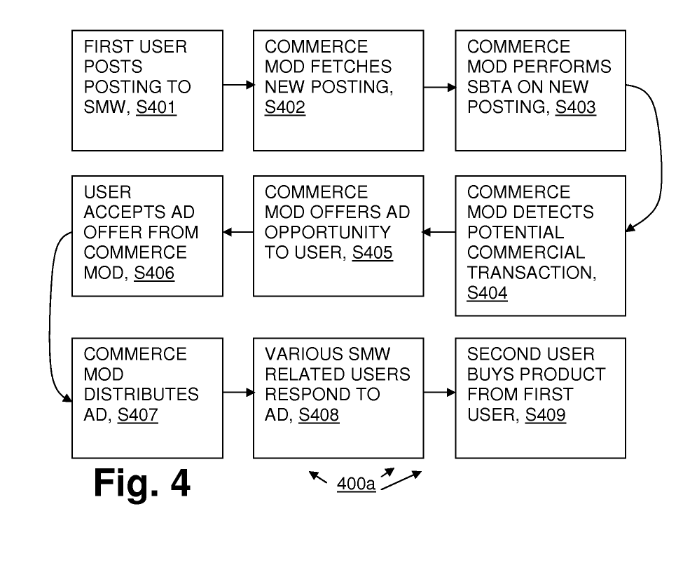

An embodiment of the present invention will now be described in detail with reference to the Figures. FIGS. 1, 2A, 2B and 3 are a functional block diagram illustrating various portions of distributed data processing system 100, including: server computer sub-system 102; client computer sub-systems 104, 106, 108, 110, 112; and data communication network 114. As shown in FIG. 2A, server computer sub-system 102 includes: server computer 200; communication unit 202; processor set 204; input/output (I/O) interface set module 206; memory 208 (including cache 232 and random access memory (RAM) 230); persistent storage device 210; display device 212; and external device set 214. Persistent storage device 210 includes commerce module 240 and SMW module 242. A shown in FIG. 2B, client computer sub-system 102 includes: client computer 250; communication unit 252; processor set 254; input/output (I/O) interface set module 256; memory 258 (including cache 272 and random access memory (RAM) 270); persistent storage device 260; display device 262; and external device set 264. Persistent storage device 260 includes operating system module 280 and browser module 282. As shown in FIG. 3, commerce module 240 includes: fetch posting sub-module 302; offer advertisement sub-module 304; accept advertisement sub-module 306; distribute advertisement sub-module 308; and SBTA sub-module 310 (including dictionary sub-sub-module 320; rules sub-sub-module 322; and analysis sub-sub-module 324).

As shown in FIG. 1, network 114 connects in data communication: server computer sub-system 102 and client computer sub-systems 104, 106, 108, 110, 112. In this example, an SMW is run, at least primarily, by server 102. Each of the client sub-systems is used by a user of the SMW. The user of client sub-system 104 will herein be called the first user, and one of her SMW postings will be discussed in detail below. The users of sub-systems 106, 108, 110 and 112 are designated as “associates” of the first user by the SMW because they are socially related to the first user, as the requisite social relationship is defined by the software of SMW module 242 that runs the SMW. For example, the first user (sub-system 104), and each of the respective users of the other sub-systems may have mutually requested to have “associate” status. This “associate” status is an example of being “SMW related” as that term is used in this document. For present purposes, the point is not so much about exhaustively defining all the ways that users of an SMW may become SMW related, but rather the concept that some users of an SMW will be SMW related to each other, and others generally will not be. FIG. 1 focuses on the users that are SMW related to the user of client sub-system 104. Generally, a user of a successful SMW will have many, many more SMW related users than the four shown for the first user in the simplified example of FIG. 1.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. As shown in FIG. 2A, SMW module 242 is a collection of machine readable instructions and data that is used to create, manage and control the social media website. For example, the software and data that makes up Facebook would be an example of an SMW module. Commerce module 240 is a collection of machine readable instructions and data that will be discussed below in some detail.

Client computer sub-system 104 may be a laptop computer, tablet computer, netbook computer, personal computer (PC), a desktop computer, a personal digital assistant (PDA), a smart phone, or any programmable electronic device capable of communicating with the server and other client sub-systems via network 114. As shown in FIG. 2B, operating system (OS) module 280 is a collection of machine readable instructions and data that is used to create, manage and control the operating system of the client computer. Browser module 282 is an internet browser which provides communications and certain user interface features for the first user (of client sub-system 104) to use the SMW to do social media website related actions and participations. Neither the operating system, nor the browser, requires extended discussion here, as these types of software are well known in the art. However, it will be mentioned that client sub-system 104 may store some portion of the instructions and/or data for creating, managing and/or controlling the SMW and/or the commerce module actions to be discussed below, as will be understood by those of skill in the art of distributed computing and/or distributed data storage.

Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1, 2A, 2B and 3, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

Turning again to FIG. 2A, server computer sub-system 102 is shown as a block diagram with many double arrows. These double arrows (no separate reference numerals) represent a communications fabric, which provides communications between various components of sub-system 102 as shown in FIG. 2A. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 of sub-system 102 may be able to supply, some or all, memory for sub-system 102; and/or (ii) devices external to sub-system 102 may be able to provide memory sub-system 102.

Commerce module (or, simply, mod) 240 and SMW mod 242 are stored in persistent storage 210 for access and/or execution by one or more of the respective computer processors 204, usually through one or more memories of memory 208. Persistent storage 210 is at least more persistent than a signal in transit is, but the persistent storage may, of course, be substantially less persistent than permanent storage. Mods 240 and/or 242 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 250. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, commerce module 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

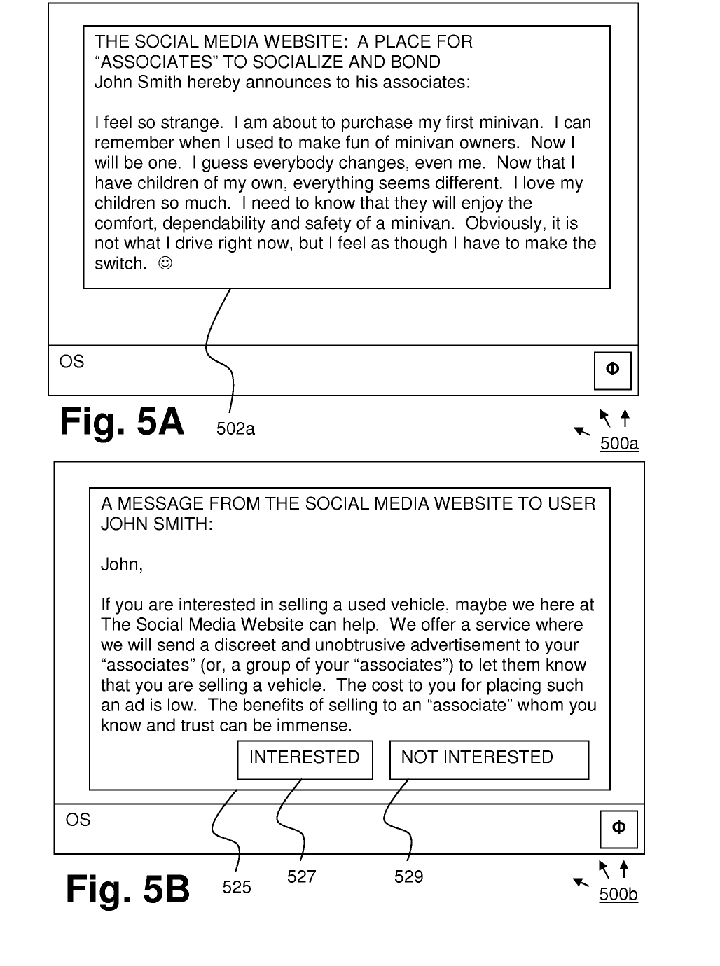

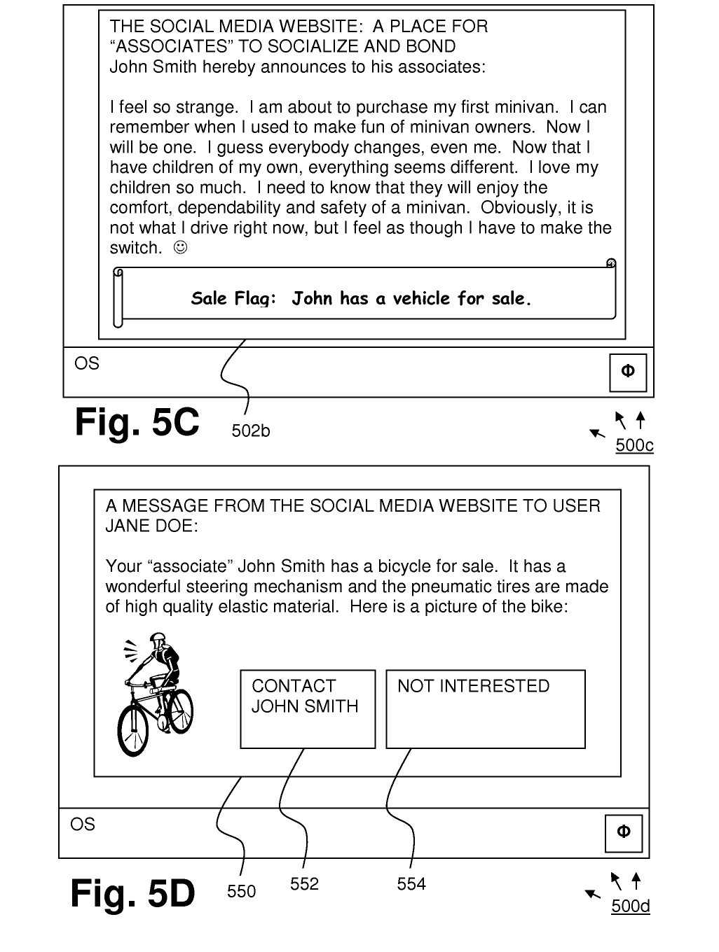

Turning now to FIG. 3, the various modules, sub-modules and/or sub-sub-modules of FIG. 3 will be woven into the discussion below of the flowchart of FIG. 4 and the screenshots of FIGS. 5A, 5B, 5D and 5C.

Turning now to FIG. 4, FIG. 4 is a flowchart depicting process 400a in accordance with an embodiment of the present invention. The various steps of process 400a will now be discussed in turn.

At step S401, the first user (that is, the user of client sub-system 104) makes a posting to an SMW. This posting is displayed to the first poster's SMW-related-users on their display devices when they use the SMW. In this example, the SMW-related-users of the first user: (i) are the users of client sub-systems 106, 108, 110 and 112; and (ii) are designated as “associates” of the first user by the particular SMW that is created, managed and controlled by server sub-system 102. Turning now to FIG. 2A, this receipt and distribution of the first user's SMW posting is managed and controlled, at least primarily, by SMW mod 242. Turning now to FIG. 5A, screenshot 500a shows window display 502a (also called SMW posting 502), which shows the way the first user's post might be displayed to her various SMW-related-users before the present invention is applied to this particular SMW posting. While the entire content of this rather lengthy post need not be recited here, it is noted that the post does not explicitly say that the first user is selling her current car, or any other sort of vehicle.

SMW posting 502a is not an advertisement because it is not advertising anything. The post does suggest that the first user is interested in buying a minivan, but it does not specify that the user is selling anything. In fact, the main rhetorical thrust of SMW posting 502a is not commerce-related at all, but, rather, related to emotional feelings that the first user is having with regard to her children and to the impending use of her prospective minivan. This is typical of social media sites, which are often not focused on commerce, at least with respect to the SMW postings that the various users make. Rather, the user is primarily concerned with expressing herself, communicating with others on a social level and/or with building social relationships. It is not that social relationships always exclude communications related to commercial activities, but they generally transcend and subsume commerce-related activities because good social relationships tend to be somewhat robust and somewhat comprehensive in that way.

In fact, it is believed that many SMW users are generally discouraged, by prevailing social “norms” currently existing in “cyberspace,” from using their SMW posts to do blatant advertising. There are exceptions to this social norm. For example, a Facebook page for an SMW user that is a restaurant business would be expected to make SMW posts that are advertisements, and these posts would show up in the “feeds” of the restaurant's SMW-related-users (in this case, called the “associates” of the restaurant).

However, for SMW posters who are not primarily commercial entities, SMW postings that are advertisements may be seen by other users as crass, because the other users may read the SMW postings of the non-commercial entity, at least in part, to take a break from the area of commerce and to acknowledge that other things in life, besides commerce, can be important and meaningful to discuss. This is regarded as part of the reason that SMWs have become as popular as they have. The present invention recognizes these tendencies and “norms” that many SMW users have, and can work to encourage them to make appropriate advertisements that they would not otherwise make and/or that it would not otherwise occur to them to even consider making.

Returning now to FIG. 4, at step S402, fetch posting sub-module 302 of commerce mod 240 (see FIGS. 2A and 3) fetches digital data corresponding to the content of new posting 502a from SMW module 242 and delivers this data to analytics sub-module 310 (see FIG. 3) for further processing. At step S403, analysis sub-sub-module 324 of sub-module 310 of module 240 performs SBTA (see explanation of SBTA in the background section) on the content of SMW posting 502a. It is noted that in this embodiment, the SMW posting that is analyzed by SBTA is in a natural language. Analysis sub-sub-module uses data from dictionary sub-sub-module 320 and rules sub-sub-module 322 in performing the SBTA wherein dictionaries and rules are used to analyze the natural language text for meaning. The SBTA sub-module may be: (i) a specially programmed software module, specifically directed at social media postings and with a view to potential commercial transactions; or (ii) a general purpose SBTA software module of a type now known or which may come to exist in the future.

At step S404, sub-sub-module 324 of module 310 makes a determination as to whether the SBTA analysis indicates that it is likely that SMW posting 502a indicates that the first user is contemplating a potential commercial transaction (see definitions section) based upon the substantive, natural language content of posting 502a. For example, the SBTA analysis might result in some type of likelihood-of-sale numerical rating, and, in this example, analysis sub-sub-module 324 would determine whether the numerical rating for posting 502a is greater than a threshold value, such that a potential commercial is sufficiently likely to be contemplated by the first user. Assuming that a potential commercial transaction is sufficiently likely, processing would proceed to step S405. If the processing of step S404 determined that a sales situation was not likely, then the processing would terminate and not proceed to step S405.

Also, sub-sub-module 324 may consider factors beyond the likelihood of a potential commercial transaction in making its determination of whether a potential advertisement opportunity exists. For example, if the first user is a restaurant, then it might not be a good idea to offer the restaurant an advertisement every time SBTA on the restaurant's posting indicates that the restaurant may have food products and/or food serving services to sell. One solution might be to categorically forego the offer of advertisements to commercial entities (and/or users who are detected to be using the SMW for primarily commercial reasons) altogether. Another solution might be to determine whether the product or service that might be for sale, as indicated by the SBTA, is the type of product or service that the SMW first user normally sells. For example, if the restaurant's posting indicates that they will be closed for remodeling, then it might be a good idea to offer the restaurant an opportunity to sell its furniture and/or kitchen appliances because the restaurant is not normally in the business of selling these items and it might not occur to the restaurant to use the SMW to sell these items. These examples are merely illustrative of the larger principle that not all postings that indicate a likely sale need to always result in an offer to the first user to have an advertisement placed.

A few other examples of SMW postings that might be expected to have a likely sale indicated by SBTA analysis: (i) if I can find a babysitter, Fred is taking me out for dinner on Saturday; (ii) I found a new job so I will probably move to Atlanta; (iii) I started a charity walk team for a medical research charity; (iv) our renters are moving out next month; (v) I lost my job due to company cutbacks; (vi) went out shopping for a new couch but had no luck; (vii) I am planning on remodeling my kitchen; and/or (viii) I just published a book. It is noted that in the foregoing example (i), the advertisement is an advertisement that the poster seeks to purchase, rather than sell, services. This may sometimes herein be referred to as a “wanted post,” but it generally works similarly to a post advertising goods or services for sale.

At step S405, offer advertisement sub-module 304 of module 240 (see FIG. 3) offers the first user an opportunity to place an advertisement. For example, screenshot 500b of FIG. 5B includes offer window display 525. Window 525 offers the first user an opportunity to advertise a vehicle for sale, to the first user's SMW-related-users, through the SMW.

At step 406, the first user can indicate his interest in proceeding to place the advertisement by selectively using buttons 527, 529. In this example, the first user is interested in going forward with the offered advertisement. In examples where the first user was not interested in the placing the advertisement, then the processing would end. Step S406 may include additional sub-steps. For example, the first user may be allowed and/or required to indicate which of his SMW-related-users would receive the advertisement, and which of his SMW-related-users would not see the advertisement. As a further example, while in some embodiments, the placement of the advertisement might be a free service, in other embodiments, the advertisement might need to be paid for. The cost and/or pricing structure of the advertisement might be communicated and/or negotiated at step S406. As examples of a couple of alternative pricing structures, the cost of the advertisement might be based on one or more of the following pricing schemes: (i) fixed price per each delivery of the advertisement to an SMW-related-user of the first user; (ii) payment for the advertisement upon a user responding to the advertisement (for example, “clicking” on the advertisement); and/or (iii) payment for the advertisement upon an SMW-related-user actually buying the product or service from the first seller.

At step S406, the first user will also have at least some input into the advertisement's content. For example, although the SBTA has indicated that a commercial transaction situation is likely, the SBTA analysis might not indicate exactly what that the relevant circumstances are. For example, the SBTA analysis may not indicate whether the potential commercial transaction relates to a desired sale by the first user, a desired purchase by the first user, a charitable commercial transaction, a rental, a barter, the exact identity and/or characteristics of the goods, the exact identity and/or characteristics of the services and so on. As can be seen at screenshot 500b of FIG. 5B, the SBTA has indicated that the first user may be selling a used vehicle. However, the first user will still need to confirm that he does indeed have a vehicle for sale and, further, what kind of a vehicle he has. In some cases, the nature of the product that the first user has for sale might cause the SMW to even refuse to place an advertisement. For example, if the first user wants to sell a vehicle that is a tank, then the SMW may decide (or have software programmed to decide) that this is not the sort of product that the SMW wants to help sell, and refuse the advertisement. As shown in FIG. 3, accept advertisement sub-module 306 of commerce module 240 manages and controls acceptance of the advertisement from the first user.

At step S407, distribute advertisement sub-module 308 of module 240 distributes the advertisement to some, or all, of the SMW-related-users of the first user. Two examples of such advertisements are respectively shown in FIGS. 5C and 5D. In screenshot 500c of FIG. 5C, the advertisement takes the form of a relatively unobtrusive “flag” that is attached to the SMW posting 502b itself. This flag would be displayed to the first user's SMW-related-users (or “associates) whenever they view posting 502 (such as viewing the posting on a “feed”). On the other hand, in FIG. 5D, advertisement window display 550 of screen shot 500d is a dedicated popup window with buttons 552, 554 for the SMW-related-users to affirmatively indicate whether or not they are interested in the first user's vehicle for sale, which, in this example, happens to be a bicycle. Many other forms of advertising are possible, both on and off of the computer network platform shown in FIG. 1.

In many cases, distribution of the advertisement will be strictly limited to SMW-related-users of the first user. In other embodiments, additional parties may receive the advertisement, such as: (i) SMW-related-users of an SMW-related-user of the first user, and/or (ii) totally unrelated third parties. However, it should be noted that, at least in some embodiments, the advertisement will be considered to be more valuable and better targeted if it is directed to people or entities that the first users knows and trusts, which is believed to generally facilitate a smooth and pleasant sales transaction. This is why it can be a valuable and special opportunity to have the advertisement be placed to, at least, if not exclusively, the first user's SMW-related-users.

Generally speaking, at the distribution of the advertisement at step S407 there are three possibilities: (i) the advertisement is placed to the recipient users (including the SMW-related-users of the first user) over the computer system in the same manner as one of the first user's posts; (ii) the advertisement is placed to the recipient users (including the SMW-related-users of the first user) over the computer system in a manner different than one of the first user's posts; and/or (iii) the advertisement is distributed in a manner other than over the computer system (for example, by direct postal mail, by telephone, etc.)

It is noted that alternative (ii) has certain powerful advantages. For example, distribution of the advertisement over the computer system (that is, alternatives (i) or (ii)) is generally probably much less obtrusive for the recipients than distribution by postal mail, telephone or the like. Also, it may be preferred, at least in some embodiments, to have the advertisement be presented over the computer system, but not be presented as a posting of the first user, as in alternative (ii). As one example of alternative (ii) type distribution of the advertisement, the SMW-related-users (for example, “Facebook friends”) may receive an email. As a further example of an “alternative (ii)” advertisement that is communicated over the computer, but is not part of the original posting itself, a banner advertisement at the SMW site (or even on other sites), could be made to display to the SMW-related-users. As a further example, the advertisement could be communicated to some, or all, recipients by email. If the SMW has a messaging system (instant messaging type and/or email type) then the advertisement might be distributed over that communication channel. Alternatively, or additionally, the advertisement could be sent to recipients email accounts which are not administered by the SMW. Herein, an “alternative (ii) advertisement” that is distributed over the computer system, but not presented as a posting of the first user will be herein referred to as an advertisement distributed over a “non-posting conduit.”

There are two different types of advertisements distributed over a non-posting conduit: (i) advertisements distributed within the SMW itself (“SMW advertisements over a non-posting conduit”); and (ii) advertisements not distributed over the SMW itself (“external advertisements over a non-posting conduit”). As an example of an external advertisement over a non-posting conduit, one example would be an email advertisement sent from the SMW to respective external (that is non-SMW administered) email accounts of SMW-related-users of the first user. Each of these types of distribution over a non-posting conduit has its respective potential advantages and disadvantages, as will be apparent to those of skill in the art.

At step S408, the recipients of the advertisement choose whether or not to respond to the advertisement (see FIG. 5D at buttons 552 and 554). If it is determined at step S408 that a “second user” wants to buy the first user's product or service then processing proceeds to step S409.

At step S409, the second user buys the product or service from the first user. Depending upon the software and system design, the degree of involvement of the SMW in the actual sales transaction may vary.

The flowchart and block diagrams in the foregoing Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising the following:
receiving a posting;
analyzing the posting to determine whether a potential commercial transaction related to natural language content of the posting is likely; and
on condition that a likely potential commercial transaction has been determined by the analyzing step, placing an advertisement to help facilitate the potential commercial transaction;
wherein at least the analyzing step is performed by computer software running on computer hardware.

2. The method of claim 1 wherein:
the posting is a social media website (SMW) posting made by a first user to an SMW.

3. The method of claim 2 wherein: at the placing step, the advertisement is directed to, at least, a set of SMW-related-users of the first user; and
the analyzing step includes natural language processing type text analytics.

4. The method of claim 3 wherein, at the placing step, the advertisement will be directed exclusively to the set of SMW-related-users of the first user.

5. The method of claim 2 further comprising the step of:
on condition that a likely potential commercial transaction has been determined by the performing step and prior to the placing step, offering the first user an opportunity to place the advertisement;
wherein the placing step is performed only on further condition that the first user accepts the opportunity at the offering step.

6. The method of claim 2 wherein the advertisement takes the form of a flag that is displayed with and/or within the SMW posting to, at least, a set of SMW-related-users of the first user.

7. A set of machine readable instructions and associated data, stored on a storage device in a manner more persistent than a signal in transit, the set comprising:
a fetch posting module programmed to receive a posting;
an analysis module programmed to analyze the posting to determine whether a potential commercial transaction related to natural language content of the posting is likely; and
a distribute advertisement module programmed to, on condition that a likely potential commercial transaction has been determined by the SBTA module, place an advertisement to help facilitate the potential commercial transaction.

8. The set of claim 7 wherein:
the posting is a social media website (SMW) posting made by a first user to an SMW.

9. The set of claim 8 wherein:
the distribute advertisement module is further programmed so that the advertisement is directed to, at least, a set of SMW-related-users of the first user; and
the analysis module is further programmed to perform natural language processing type text analytics.

10. The set of claim 9 wherein the distribute advertisement module is further programmed so that the advertisement will be directed exclusively to the set of SMW-related-users of the first user.

11. The set of claim 8 further comprising:
an accept advertisement module programmed to, on condition that a likely potential commercial transaction has been determined by the SBTA module, offer the first user an opportunity to place the advertisement.

12. The set of claim 8 wherein the distribute advertisement module is further programmed so that the advertisement takes the form of a flag that is displayed with and/or within the SMW posting to, at least, a set of SMW-related-users of the first user.

13. A computer system comprising:
a processing hardware set; and
a storage device;
wherein:
the storage device is structured, connected and/or programmed has stored therein a set of machine readable instructions and associated data;
the processing hardware set is structured, connected and/or programmed to perform the machine readable instructions of the set of machine readable instructions and associated data; and
the set of machine readable instructions and associate data comprises:
a fetch posting module programmed to receive a posting;
an analysis module programmed to process the posting to determine whether a potential commercial transaction related to natural language content of the posting is likely; and
a distribute advertisement module programmed to, on condition that a likely potential commercial transaction has been determined by the SBTA module, place an advertisement to help facilitate the potential commercial transaction.

14. The system of claim 13 wherein:
the posting is a social media website (SMW) posting made by a first user to an SMW.

15. The system of claim 14 wherein:
the distribute advertisement module is further programmed so that the advertisement is directed to, at least, a set of SMW-related-users of the first user; and
the analysis module is further programmed to perform natural language processing type text analytics.

16. The system of claim 15 wherein the distribute advertisement module is further programmed so that the advertisement will be directed exclusively to the set of SMW-related-users of the first user.

17. The system of claim 14 further wherein the set of machine readable instructions and associated data further comprises:
an accept advertisement module programmed to, on condition that a likely potential commercial transaction has been determined by the SBTA module, offer the first user an opportunity to place the advertisement.

18. The system of claim 14 wherein the distribute advertisement module is further programmed so that the advertisement takes the form of a flag that is displayed with and/or within the SMW posting to, at least, a set of SMW-related-users of the first user.
